(19) United States
(12) Patent Application Publication
(10) Pub. No.: US 2003/0224531 A1
(43) Pub. Date: Dec. 4, 2003

(54) Microplate with an integrated microfluidic system for parallel processing minute volumes of fluids

(76) Inventors: Reid A. Brennen, San Francisco, CA (US); Kevin Patrick Killeen, Palo Alto, CA (US); Hongfeng Yin, San Jose, CA (US)

Correspondence Address: Michael Beck, AGILENT TECHNOLOGIES, INC., 1601 California Avenue, Palo Alto, CA, 94304-1126, US

(21) Appl. No.: 10/157,803

(22) Filed: May 29, 2002

(51) Int. Cl. B01L 3/00

(52) U.S. Cl. 436/180; 422/102; 422/99

(57) ABSTRACT

A microanalytical device is provided for conducting multiple chemical and/or biochemical reactions and analyzing multiple sample fluids in parallel using minute volumes of reaction or sample fluid. The devices comprises a well plate with an integrated microfluidic system containing processing compartments such as microcavities, microchannels and the like, that are in fluid communication with electrospray emitters. The novel microanalytical device can be used in a variety of chemical and biochemical contexts, including mass spectroscopy, chromatographic, electrophoretic and electrochromatographic separations, screening and diagnostics, and chemical and biochemical synthesis. The devices may be formed from a material that is thermally and chemically stable and resistant to biofouling, significantly reducing electroosmotic flow and unwanted adsorption of solute.

### TECHNICAL FIELD

This invention relates generally to the field of miniaturized devices for conducting chemical processes, and more particularly relates to novel microanalytical devices comprised of a microplate integrated with a microfluidic system for conducting chemical processes such as mass spectroscopy, separation (e.g., chromatographic, electrophoretic or electrochromatographic separation), screening and diagnostics (using, e.g., hybridization or other binding means), and chemical and biochemical synthesis (e.g., DNA amplification conducted using the polymerase chain reaction, or “PCR”).

### BACKGROUND

Chemical processing, storage, and transfer of chemicals for analysis, especially in biologically related fields, commonly make use of well plates containing a plurality of wells, each well typically adapted to contain a relatively small volume of fluid (in which case the well plates may be referred to as “microplates”). Commercially available well plates include those having 96, 384, or 1536 wells. Currently, most processes involving such microplates require the transfer of fluids or materials to and/or from the individual wells. If these processes can be avoided, several steps in any analysis or process may be removed, thus saving time, reducing mechanical complexity, reducing fluid volumes, and reducing the necessary quantities of rare and/or expensive reagents that are often used in microfluidic processes.

Recently, those working in the field of microfluidics have been able not only to reduce the required fluid volumes in various types of analyses, but also to conduct increasingly complex processes, substantially increasing the types of applications with which microfluidic systems can be used. In analytical instrumentation, smaller dimensions generally result in improved performance characteristics and at the same time result in reduced production and analysis costs. Miniaturized separation systems, for example, provide more effective system design, result in lower overhead, and enable increased speed of analysis, decreased sample and solvent consumption and the potential for increased detection efficiency.

Accordingly, several approaches have been developed in connection with miniaturization of devices for use in chemical analysis, particularly in mass spectroscopy, microcolumn liquid chromatography (μLC), wherein columns with diameters of 100 to 200 microns are used, in capillary electrophoresis (CE), wherein electrophoretic separation is conducted in capillaries on the order of 25 to 100 microns in diameter, and in microchannel electrophoresis (MCE), wherein electrophoresis is carried out within a microchannel on a substantially planar substrate. The conventional approach in miniaturization technology as applied to CE and μLC involves use of a silicon-containing material, i.e., a capillary fabricated from fused silica, quartz or glass. With MCE, an attractive method that is useful in conjunction with high throughput applications and enables reduction in overall system size relative to CE, miniaturized devices have been fabricated by silicon micromachining or lithographic techniques, e.g., microlithography, molding and etching. See, for example, Fan et al. (1994) Anal. Chem. 66(1):177-184; Manz et al., (1993) Adv. in Chrom. 33:1-66; Harrison et al. (1993), Sens. Actuators, B B10(2):107-116; Manz et at. (1991), Trends Anal. Chem. 10(5):144-149; and Manz et at. (1990) Sensors and Actuators B (Chemical) B1(1-6):249-255.

The use of micromachining techniques to fabricate miniaturized separation systems in silicon provides the practical benefit of enabling mass production of such systems, and there are a number of techniques that have now been developed by the microelectronics industry for fabricating microstructures from silicon substrates. Examples of such micromachining techniques to produce miniaturized separation devices on silicon or borosilicate glass chips can be found in U.S. Pat. Nos. 5,194,133 to Clark et al., 5,132,012 to Miura et al., 4,908,112 to Pace, and 4,891,120 to Sethi et al. Other types of substrates, such as those composed of polymeric or ceramic materials, also lend themselves to fabrication of extraordinarily small features.

For the foregoing reasons, it would be desirable to provide a microanalytical device that integrates a microplate with a microfluidic system into a single device that provides the benefits of both technologies, with the microplate enabling one to work with a large number of samples in individual processing chambers, and the microfluidic system allowing for various types of analyses, diagnostic tests, and reactions to be conducted, preferably in parallel, with the plurality of samples. The present invention provides such microanalytical devices, and preferably employs high-density microplates to maximize the number of parallel processes that can be carried out using the microfluidic system.

### SUMMARY OF THE INVENTION

The present invention addresses the aforementioned needs in the art, and provides a novel microanalytical device in which multiple chemical and biochemical reactions can be conducted in parallel, preferably using minute volumes of fluids. In its simplest embodiment, the microanalytical device comprises a wellplate having integrated microfluidics and electrospray emitter that are each capable of delivering a sample to a mass spectrometer.

The integrated microfluidics may be formed by the joining of a microfluidic housing having first and second substantially planar opposing surfaces, with a plurality of cavities and microchannels formed in the first substantially planar opposing planar surface, wherein each cavity is in fluid communication with both (i) an upstream microchannel that is in turn in fluid communication with an associated inlet port and (ii) a downstream microchannel that is in fluid communication with an associated outlet port that is in turn in fluid communication with an associated electrospray emitter; and a cover plate affixed to the first substantially planar surface. Arrangement of the cover plate over the first substantially planar surface defines a plurality of independent, parallel sample processing compartments, with the covered cavities typically representing process zones or reaction chambers, and the covered microchannels serving as microcolumns through which fluid may flow. Each sample processing compartment extends through the device from an associated inlet port to a corresponding outlet port. Each outlet port is in turn in fluid communication with an electrospray emitter, i.e., a mass spectroscopy tip or nozzle. Each well in the well plate is in fluid communication with one of the associated inlet ports, or is capable of such fluid communication, e.g., if the microfluidic housing and cover plate are properly aligned or realigned with respect to each other.

The wellplate may be integrated with the microfluidic housing or the cover plate and each well in the well plate is capable of fluid communication with an inlet port of a sample processing compartment. The independent, parallel sample processing compartments are each capable of receiving and processing a sample so that the device is capable of processing a plurality of samples in a parallel manner.

As discussed above, the device is generally comprised of a microfluidic housing having first and second substantially planar opposing surfaces and a plurality of cavities and microchannels formed in the first surface, which typically, although not necessarily, serves as the upper surface when the device is in use. Each cavity is in fluid communication both with an upstream microchannel that is in turn in fluid communication with an associated inlet port, and with a downstream microchannel that is also in fluid communication with an associated outlet port. A cover plate is then arranged over the first surface thereby defining the plurality of independent, parallel sample processing compartments, with the covered cavities typically representing process zones or reaction chambers, and the covered microchannels serving as microcolumns through which fluid may flow.

The device is preferably composed of a material that is thermally and chemically stable and resistant to biofouling. Preferred materials are those that exhibit reduced adsorption of solute, e.g., biomolecules such as proteins, nucleic acids, etc., and can be modified, coated or otherwise treated so as to optimize electroosmotic flow. In contrast to prior microanalytical systems, the present devices are useful in connection with a wide variety of processes, including not only mass spectrometric, electrophoretic, chromatographic and electrochromatographic separations, but also other chemical and biochemical processes that may involve high temperatures, extremes of pH, harsh reagents, or the like. Such processes include, but are not limited to, screening and diagnostics (using, e.g., hybridization or other binding means), and chemical and biochemical synthesis (e.g., DNA amplification, as may be conducted using PCR).

The invention also provides a method for transporting a plurality of liquid samples to amass spectrometer in parallel, using the above-described microanalytical device. Reaction or sample fluid is introduced into each of the sample treatment components through the inlet ports, if desired, a reaction is conducted in a sample treatment “component” that serves as a reaction chamber, and then the sample fluid or the product of each reaction may be collected upon removal from the reaction chamber through the outlet ports. The outlet ports are in fluid communication with electrospray emitters that are capable of transferring the reaction or sample fluid into a mass spectrometer and removal of the sample or reaction fluid may be via injection of the sample or reaction fluids into a mass spectrometer. Microchannels present in fluid communication with the sample treatment components may be used to increase the concentration of a particular analyte or chemical component in a sample or reaction fluid prior to processing in the reaction chamber, to remove potentially interfering sample or reaction components, to conduct preparative procedures prior to chemical processing in the reaction chamber, and/or to isolate and purify the desired product.

### BRIEF DESCRIPTION OF THE DRAWINGS

FIG. 1 is a perspective view of one embodiment of a microanalytical device of the invention.

FIG. 2 is a perspective view of a second embodiment of a microanalytical device of the invention.

FIG. 3 is a perspective view of a third embodiment of a microanalytical device of the invention.

FIG. 4 is a perspective view of a fourth embodiment of a microanalytical device of the invention.

FIG. 5 is a top plan view of a representative inlet port.

FIG. 6 is a photograph of one embodiment of the inventions.

### DETAILED DESCRIPTION OF THE INVENTION

Before the invention is described in detail, it is to be understood that unless otherwise indicated this invention is not limited to particular materials, components or manufacturing processes, as such may vary. It is also to be understood that the terminology used herein is for purposes of describing particular embodiments only, and is not intended to be limiting. It must be noted that, as used in the specification and the appended claims, the singular forms “a,” “an” and “the” include plural referents unless the context clearly dictates otherwise. Thus, for example, reference to “a material” includes a single material as well as a combination or mixture of materials, reference to “a sample processing component” includes a single sample processing component as well as multiple sample processing components, and the like.

In this specification and in the claims that follow, reference will be made to a number of terms that shall be defined to have the following meanings:

The term “microanalytical device” refers to a device having features of micron or submicron dimensions, and that can be used in any number of chemical processes involving very small amounts of fluid, on the order of about 1 nL to about 500 μl, typically about 100 nl to 10 μl. Such processes include, but are not limited to, electrophoresis (e.g., CE or MCE), chromatography (e.g., μLC), screening and diagnostics (using, e.g., hybridization or other binding means), and chemical and biochemical synthesis (e.g., DNA amplification as may be conducted using the polymerase chain reaction, or “PCR”). The features of the microanalytical devices are adapted to the particular use. For example, microanalytical devices that are used in separation processes, e.g., MCE, contain microchannels (termed “microcolumns” herein when enclosed, i.e., when the cover plate is in place on the microchannel-containing substrate surface) on the order of 1 μm to 200 μm in diameter, typically 10 μm to 75 μm in diameter, and approximately 0.1 to 50 cm in length. Microanalytical devices that are used in chemical and biochemical synthesis, e.g., DNA amplification, will generally contain process zones (termed “reaction chambers” herein when enclosed, i.e., again, when the cover plate is in place on the microchannel-containing substrate surface) having a volume of about 1 μl to about 500 μl, typically about 10 μl to 200 μl.

As used herein, the term “biofouling” refers to fouling caused by accumulated biomaterials such as proteins, protein fragments, or other biomaterials present in sample or reaction fluids that attach or adhere to the interior surfaces of the microanalytical device

As used herein, the term “detection means” refers to any means, structure or configuration that allows one to interrogate a sample within a microanalytical device of the invention using analytical detection techniques, typically although not necessarily techniques that are known in the art. Thus, a detection means can comprise one or more openings that communicate with, for example, a reaction chamber or microcolumn, and allow an external detection device to be interfaced with the chamber or microcolumn to detect an analyte therein. By the arrangement of two detection means on either side of a reaction chamber or microcolumn, a “detection path” is formed, allowing detection of analytes passing through the reaction chamber using detection techniques well known in the art. An “optical detection path” refers to a configuration or arrangement of detection means to form a path whereby electromagnetic radiation is able to travel from an external source to a means for receiving radiation, wherein the radiation traverses the reaction chamber, microchannel, or the like. In this configuration, analytes passing through the microanalytical device can be detected via transmission of radiation orthogonal to the direction of fluid flow. A variety of external optical detection techniques can be readily interfaced with the present microanalytical devices, including, but not limited to, UV/Vis, Near IR, fluorescence, refractive index (RI) and Raman techniques. Detection means can also comprise a mass spectrometer. In this configuration, the outlet ports may take the form of electrospray emitters, i.e., nozzles or tips that are capable of injecting or transferring the sample or reaction fluids into a mass spectrometer.

As used herein, a “transparent substance” refers to a substance capable of transmitting light of different wavelengths. Thus, a “transparent sheet” is defined as a sheet of a substance that is transmissive to specific types of radiation or particles of interest. Transparent sheets that may be employed in conjunction with the invention are formed from materials such as quartz, sapphire, diamond and fused silica, or from polymeric materials such as polystyrene and styrenebutadiene copolymer. “Optically transparent” refers to a material capable of transmitting light of wavelengths in the range of about 150 nm to 800 nm.

A “detection intersection” refers to a configuration wherein a plurality of detection means communicate with the interior of the present microanalytical devices at a particular location therein. A number of detection techniques can be simultaneously performed on a sample or separated analyte at the detection intersection. A detection intersection is formed when a plurality of detection paths cross, or when a detection means such as an aperture communicates with the separation compartment at substantially the same point as a detection path. The sample, or a separated analyte, can thus be analyzed using a combination of mass spectroscopy, UV/Vis and fluorescence techniques, optical and electrochemical techniques, optical and electrical techniques, or like combinations to provide highly sensitive detection information. See, e.g., Beckers et al. (1988) J. Chromatogr. 452:591-600; and U.S. Pat. No. 4,927,265, to Brownlee.

The term “liquid phase analysis” is used to refer to any analysis that is carried out on a solute in the liquid phase. Accordingly, “liquid phase analysis” as used herein includes chromatographic separations, electrophoretic separations, and electrochromatographic separations. The general term “analysis” refers to characterization of a sample or identification of one or more components therein, and is distinct from a chemical or biochemical “process” in which a material is chemically or biochemically altered to produce a desired product.

“Chromatographic” processes generally comprise preferential separations of components, and include reverse-phase, hydrophobic interaction, ion exchange, molecular sieve chromatography, and like methods.

An “electrophoretic” separation refers to the migration of particles or macromolecules having a net electric charge where said migration is influenced by an electric field. Accordingly, electrophoretic separations include separations performed in columns packed with gels (such as polyacrylamide, agarose and combinations thereof) as well as separations performed in solution.

“Electrochromatographic” separation refers to separations effected using a combination of electrophoretic and chromatographic techniques. Exemplary electrochromatographic separations include packed column separations using electromotive force (Knox et al. (1987) Chromatographia 24:135; Knox et al. (1989) J. Liq. Chromatogr 12:2435; Knox et al. (1991) Chromatographia 32:317), and micellar electrophoretic separations (Terabe et al. (1985) Anal. Chem. 57:834-841).

The term “injection molding” is used to refer to a process for molding plastic or ceramic shapes by injecting a measured quantity of a molten plastic or ceramic material into a die or molds. In one embodiment of the present invention, miniaturized devices can be produced using injection molding.

The term “embossing” is used to refer to a process for forming polymer, metal or ceramic shapes by bringing an embossing die into contact with a pre-existing blank of polymer, metal or ceramic. A controlled force is applied between the embossing die and the pre-existing blank of material such that the pattern and shape determined by the embossing die is pressed into the pre-existing blank of polymer, metal or ceramic. The term “hot embossing” is used to refer to a process for forming polymer, metal or ceramic shapes by bringing an embossing die into contact with a heated pre-existing blank of polymer, metal or ceramic. The pre-existing blank of material is heated such that it conforms to the embossing die as a controlled force is applied between the embossing die and the pre-existing blank. The resulting polymer, metal or ceramic shape is cooled and then removed from the embossing die.

The term “LIGA process” is used to refer to a process for fabricating microstructures having high aspect ratios and increased structural precision using synchrotron radiation lithography, galvanoforming, and plastic molding. In a LIGA process, radiation sensitive plastics are lithographically irradiated with high energy radiation using a synchrotron source to create desired microstructures (such as channels, ports, apertures, and micro-alignment means), thereby forming a primary template.

The term “motive force” is used to refer to any means for inducing movement of a sample along a column in a liquid phase analysis, and includes application of an electric potential across any portion of the column, application of centrifugal force, application of a pressure differential across any portion of the column, or any combination thereof. Electrokinetic high pressure hydraulic systems such as those disclosed in U.S. Pat. Nos. 6,013,164, 6,019,882, and 6,277,257 all to Paul et al. are also suitable for use in the microanalytical devices of the present invention.

“Optional” or “optionally” as used herein means that the subsequently described feature or structure may or may not be present, or that the subsequently described event or circumstance may or may not occur, and that the description includes instances where a particular feature or structure is present and instances where the feature or structure is absent, or instances where the event or circumstance occurs and instances where it does not.

### THE INTEGRATED MICROANALYTICAL DEVICE

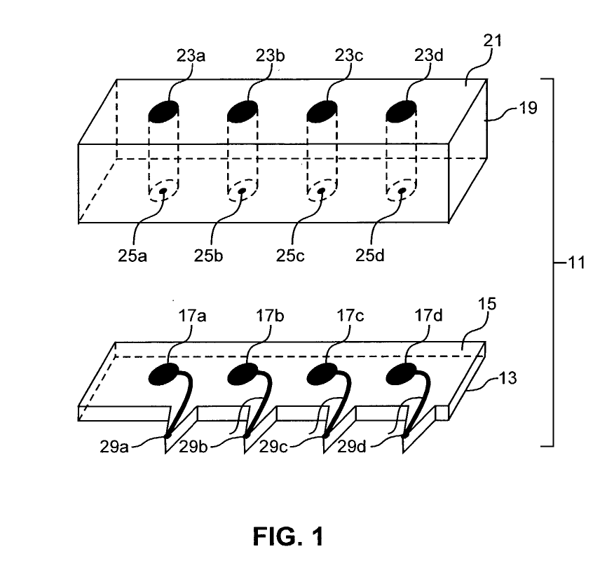

One embodiment of the present invention is represented in FIG. 1, which illustrates a microanalytical device that can be used in conducting a chemical process (e.g., PCR) or processing a sample prior to analysis with an analytic device such as a mass spectrometer. The device is generally represented at 11, comprising a microfluidic housing 13 having a substantially planar surface 15 containing process zones 17a, 17b, 17c, and 17d in the form of shallow cavities, i.e., cavities having a depth of micron or even submicron dimensions. A cover plate 19 is shown arranged over microfluidic housing 13. The upper surface 21 of the cover plate contains a plurality of individual wells 23a, 23b, 23c, and 23d each connected to inlet ports 27a, 27b, 27c, and 27d, respectively, located on the underside 25 of the cover plate. While only four wells have been depicted, it will be appreciated by those of skill in the art that the wells may number and be arranged in standard spacing arrangements, i.e., in the pattern of a 94-well, 384-well, 1536-well, or an even higher density well plate. The use of such standard well arrangements allows for the simple and efficient transfer of samples and/or reaction fluids from stand size storage plate using conventional microfluidic transfer techniques.

Prior to use of the device, the underside 25 of the cover plate is aligned with and placed adjacent to the surface 15 of microfluidic housing 13. The cover plate, in combination with the process zones 17a, 17b, 17c, and 17d, forms the sample processing components in which the desired chemical processes are carried out. Fluid, e.g., sample to be analyzed, analytical reagents, reactants or the like, are introduced into the sample processing components from the individual wells 23a, 23b, 23c, and 23d through inlet ports 27a, 27b, 27c, and 27d, respectively; outlet ports 29a, 29b, 29c, and 29d, which in this embodiment are comprised of electrospray emitters, enable passage of fluid from the sample processing components to an analytical device such as a mass spectrometer. Accordingly, “closure” of the device by aligning the cover with the microfluidic housing and forming a seal therebetween results in formation of the sample processing components into which fluids may be introduced through inlet ports 27a, 27b, 27c, and 27d and removed through electrospray emitters 29a, 29b, 29c, and 29d. That is, the covered cavities serve as enclosed reaction chambers, while the covered microchannels are enclosed microcolumns allowing the passage of fluid therethrough. Preferably, a liquid-tight seal is formed by using pressure sealing techniques, by using external means to urge the pieces together (such as clips, tension springs or associated clamping apparatus), and/or by using adhesives well known in the art of bonding polymers, ceramics and the like.

Outlet ports 29a, 29b, 29c, and 29d comprise electrospray emitters, i.e., nozzles or tips that are capable of transferring the sample or reaction fluids to an associated mass spectrometer. The electrospray emitters may be “on-device,” as shown in this embodiment, or directly integrated into the substrate in which the outlet port is housed or may be connected to the outlet port via a flexible or inflexible conduit. If on-device, the electrospray emitters can be formed directly from the substrate material or can be manufactured separately and then inserted into the substrate. The electrospray emitters may be any conventional nozzle or tip that is capable of transferring the sample or reaction fluid into an analytical device, such as a mass spectrometer. Conventional electrospray emitters include, but are not limited to, glass or silica capillary nozzles, recessed well nozzles, and nozzles comprised of polymeric tips.

An electrospray emitter is a device that allows ions to be produced from the sample or reaction fluid and introduced into an analytical device such as a mass spectrometer. Typically, free ions are produced from a liquid exiting a spray tip by inducing an electric field between the spray tip and an electrode near the orifice of the analytical device. The electric field causes the liquid to be drawn away from the spray tip and separate into smaller and smaller droplets until all liquid has evaporated only ions remain. In one type of electrospray emitter, ions are produced in a spray chamber of an analytical device by passing a fluid sample through a capillary. The capillary serves as an electrospray emitter and has one terminus subjected to an electric field. The electric field is usually generated by placing a source of electrical potential, e.g., an electrode or sample introduction orifice, near the capillary end, wherein the electrode is held at a voltage potential difference with respect to the capillary end. As a result, a large electric gradient is created at the terminus of the electrospray emitter. It should be evident that the emitter may be operated in a positive or negative ion mode by creating a positive or negative voltage gradient, respectively. In either case, the electric field influences the shape of the fluid sample at the terminus of the emitter.

When no electric field is applied, the shape of sample or reaction fluid emerging from the terminus of the emitter is a function of the surface energy of the sample, the terminus surface wetted by the fluid sample and gravitational forces. Thus, an uncharged fluid sample generally forms a round droplet on the terminus surface of the emitter as it emerges from within the emitter. However, once charged by a nearby source of electrical potential, the ordinarily round droplet of fluid sample becomes distorted and assumes the shape of a cone, commonly referred to in the art as a “Taylor cone,” (see, e.g., Ramsey et al. (1997), “Generating Electrospray from Microchip Devices Using Flectoosmotic Pumping,” Anal. Chem. 69: 1174-78) pointing toward the electrical potential source. This is because ions within the fluid samples are attracted to the electrode but cannot escape from the sample. At a sufficiently high electrical field, the Taylor cone becomes destabilized, droplets are pulled away from the cone and the droplets are dispersed into even smaller charged droplets within the spray chamber. These droplets are then directed from the emitter toward an analytical device inlet and optionally subjected to solvent evaporation and fission. As a result, ions, gaseous or otherwise, may be generated and introduced into the analytical device. When the analytical device is a mass spectrometer, the ions are introduced into the mass spectrometer's vacuum and subjected to mass-spectrometric analysis.

Generally, the performance of an electrospray emitter is limited in large part by its overall geometry, which in turn is determined by the technique used to fabricate the emitter. A number of electrospray emitter shaping techniques have been described and include, e.g., ordinary semiconductor fabrication techniques. These semiconductor fabrication techniques may be used to form electrospray devices from silicon (see, e.g., International Patent Publication No. WO 98/35376 and Schultz et al. (1999) “A Fully Integrated monolithic Microchip-Microfluidic housingd Electrospray Device for Microfluidic Separations,” 47^{th} ASMS Conference on Mass Spectrometry and Allied Topics), from glass (see, e.g., Xue et al. (1997) “Multichannel Microchip Electrospray Mass Spectrometry,” Anal Chem. 69:426-30) or from plastic (see, e.g., Licklider et al. (2000) “A Micromachined Chip Microfluidic housingd Electrospray Source for Mass Spectrometry,” Anal. Chem. 72:367-75).

Electrospray tips or nozzles wherein a port is provided on an unbounded surface of a microdevice from which fluid sample is dispersed are disclosed in U.S. Pat. No. 5,872,010 to Karger et al. and Ramsey et al. (1997), “Generating Electrospray from Microchip Devices Using Electoosmotic Pumping,” Anal. Chem. 69: 1174-78.

The electrospray emitter may be formed separately from the microdevice and then attached to the microdevice. This approach may use any of a number of emitter shaping techniques as described by the publications and patents listed above or other techniques which are well known in the art. In addition, a number of publications describe methods in which separately formed electrospray emitters may be attached to microdevices. For example, it has been described that a separately formed nano-electrospray capillary can be inserted into or be brought in proximity to a channel on a microdevice. See, e.g., International Patent Publication No. WO 00/022409; Figeys et al. (1997), “A Microfabricated Device for Rapid Protein Identification by Microelectrospray Ion Trap Mass Spectrometry,” Anal. Chem. 69:3153-60; Zhang et al. (1999), “A Microfabricated Devices for Capillary Electrophoresis-Electrospray Mass Spectrometry,” Anal. Chem. 71:3258-64; Li et al. (2000), “Separation and Identification of Peptide from Gel Isolated Membrane Proteins Using a Micromachined Device for Combined Capillary Electrophoresis,” Anal. Chem. 72:799-609; and Zhang et al. (2000), “A Microdevice with Integrated Liquid Junction for Facile Peptide and Protein Analysis by Capillary Electrophoresis/Electrospray Mass Spectrometry,” Anal. Chem. 72:1015-22.

Commonly owned U.S. patent application Ser. No. 09/324,344 (“Miniaturized Device for Sample Processing and Mass Spectroscopic Detection of Liquid Phase Samples”) inventors Yin, Chakel and Swedberg (claiming priority to Provisional Patent Application No. 60/089,033) describes a miniaturized device for sample processing and mass spectroscopic detection of liquid phase samples. The described device comprises a substrate having a feature on a surface in combination with a cover plate. Together, a protrusion on the substrate and a corresponding protrusion on the cover plate may form an on-device mass spectrometer delivery means.

Other suitable electrospray emitters are tips are disclosed in commonly assigned U.S. patent application Ser. No. 09/711,804, (A Microdevice Having An Integrated Protruding Electrospray Emitter And A Method For Producing The Microdevice) filed Nov. 13, 2000, which discloses microdevices having an integrated and protruding electrospray emitter for sample ionization in mass spectrometry and to a method for producing the emitter.

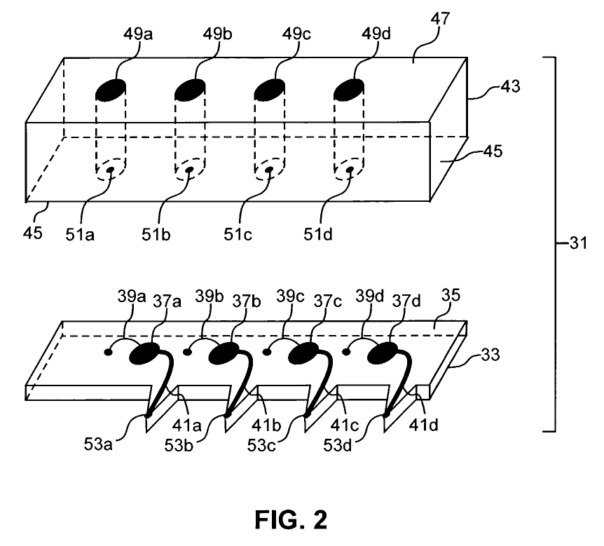

In a related embodiment of the invention, as illustrated in FIG. 2, flow paths in the form of microchannels are incorporated into the device at either end of the sample treatment component. That is, device 31 includes a microfluidic housing 33 having a substantially planar surface 35 containing a process zones 37a, 37b, 37c, and 37d, again in the form of shallow cavities. Upstream microchannels 39a, 39b, 39c, and 39d in the substrate surface are in fluid communication with the upstream region of process zones 37a, 37b, 37c, and 37d, while downstream microchannels 41a, 41b, 41c, and 41d are in fluid communication with the downstream regions of process zones 37a, 37b, 37c, and 37d. The cover plate 43 is shown arranged over microfluidic housing 33 with its underside 45 facing the surface of the microfluidic housing. The upper surface 47 of the cover plate contains a plurality of individual wells 49a, 49b, 49c, and 49d each connected to an inlet port 51a, 51b, 51c, and 51d located on the underside of the cover plate. The underside 45 of the cover plate is aligned with the microfluidic housing and placed against surface 35 prior to use of the device. Closure of the device in this manner, i.e., by aligning the cover with the microfluidic housing and forming a seal therebetween results in formation of the sample treatment components, an upstream microcolumn and a downstream microcolumn. Upon closure of the device, inlet port 51a, 51b, 51c, and 51d in the cover plate allow introduction of fluid from the individual wells 49a, 49b, 49c, and 49d into the upstream microcolumns, while electrospray emitters 53a, 53b, 53c, and 53d, located in the microfluidic housing, allow removal of fluid from the downstream microcolumns.

The upstream microcolumns may be used as a concentrating means to increase the concentration of a particular analyte or chemical component prior to chemical processing in the reaction chamber. Unwanted, potentially interfering sample or reaction components can also be removed using the upstream microcolumns. In addition, or in the alternative, the upstream microchannels can serve as microreactors for preparative chemical or biochemical processes prior to chemical processing in the sample treatment components. Such preparative processes can include labeling, protein digestion, and the like. The downstream microcolumns may be used as a purification means to remove unwanted components, unreacted materials, etc. from the reaction chamber following completion of chemical processing. This may be accomplished, for example, by packing the downstream microcolumn or coating its interior surface with a material that selectively removes certain types of components from a fluid or reaction mixture.

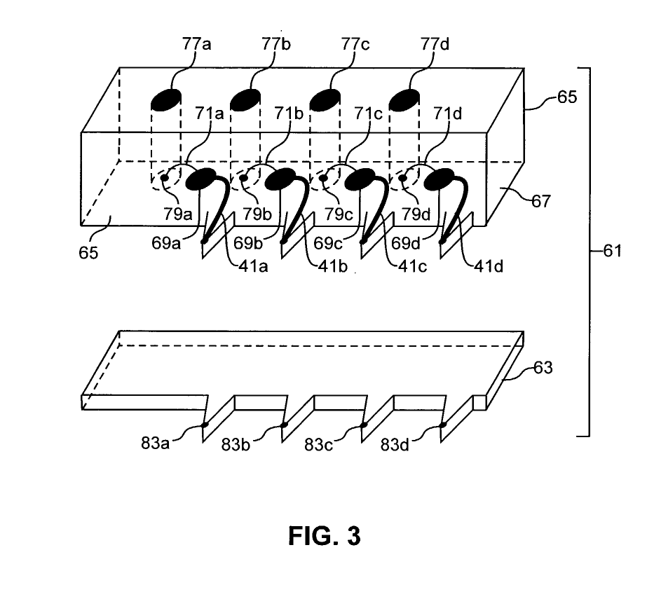

An example of a device wherein the well plate is integrated with the microfluidic housing is illustrated in FIG. 3, shown generally at 61. The embodiment comprised a microfluidic housing 65 and cover plate 63 aligned therewith. The underside surface 67 of the microfluidic housing contains a plurality of process zones 69a, 69b, 69c, and 69d, again in the form of shallow cavities. Upstream microchannels 71a, 71b, 71c, and 71d in the substrate surface are in fluid communication with the upstream region of process zones 69a, 69b, 69c, and 69d, while downstream microchannels 73a, 73b, 73c, and 73d are in fluid communication with the downstream regions of process zones 69a, 69b, 69c, and 69d. The upper surface 75 of the microfluidic housing contains a plurality of individual wells 77a, 77b, 77c, and 77d each connected to an inlet port 79a, 79b, 79c, and 79d which are in fluid communication with the process zones. The underside 67 of the microfluidic housing is aligned with the cover plate 63 and placed against the upper surface of the cover plate 63 prior to use of the device. Closure of the device in this manner, i.e., by aligning the cover with the microfluidic housing and forming a seal therebetween results in formation of the sample treatment components. Upon closure of the device, inlet ports 79a, 79b, 79c, and 79d in the microfluidic housing allow introduction of fluid from the individual wells 77a, 77b, 77c, and 77d into the sample treatment components, while electrospray emitters 83a, 83b, 83c, and 83d, located in the cover plate, allow removal of fluid from the sample treatment components. In this embodiment and in the embodiments of FIGS. 1 and 2, the microfluidic housing and cover plate may be joined at one edge, such that closure of the device is effected by folding the cover plate onto the microfluidic housing. The edge may include a fold means such as a row of spaced-apart perforations, depressions or apertures, having any shape, e.g., circular, diamond, hexagonal, etc., that promote folding and thus hinge formation.

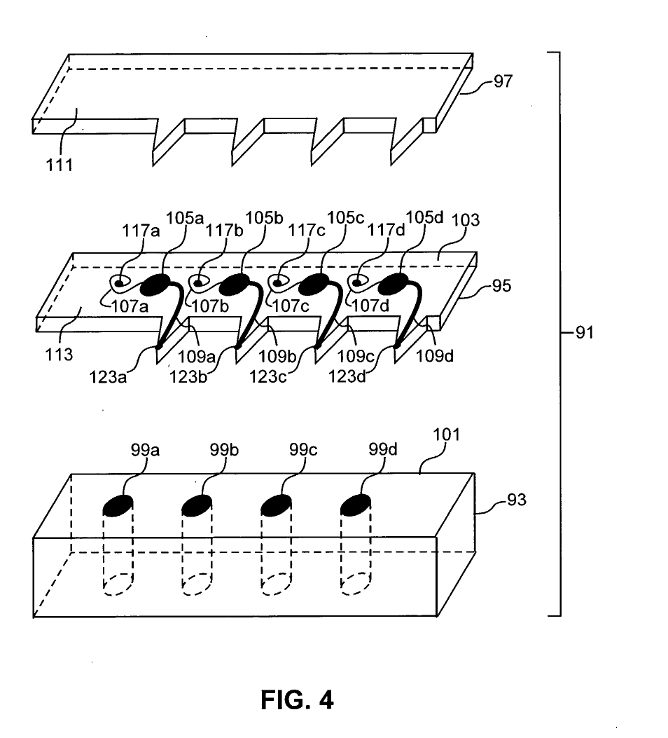

The device may also be fabricated so that the integrated microfluidics are placed over the individual wells. An example of such a device is illustrated in FIG. 4, shown generally at 91 as comprising a well plate housing, 93, a microfluidic housing 95 and top plate 97 aligned therewith. The well plate housing contains a plurality of individual wells 99a, 99b, 99c, and 99d. Positioned above the upper surface of the well plate housing 101 is the microfluidic housing 95. The microfluidic housing is provided with a substantially planar upper surface 103 containing process zones 105a, 105b, 105c, and 105d, again in the form of shallow cavities. Upstream microchannels 107a, 107b, 107c, and 107d in the substantially planar surface are in fluid communication with inlet ports 117a, 117b, 117c, and 117d and the upstream region of process zones 105a, 105b, 105c, and 105d, while downstream microchannels 109a, 109b, 109c, and 109d are in fluid communication with the downstream regions of process zones 105a, 105b, 105c, and 105d and terminate in electrospray emitters 123a, 123b, 123c, and 123d. The top plate 97 is shown arranged over microfluidic housing 95 with its underside 111 facing the substantially planar upper surface of the microfluidic housing. The top plate is aligned with and placed against the substantially planar upper surface 103 of the microfluidic housing while the underside of the microfluidic housing 113 is aligned with and placed against the upper surface of the well plate housing 101 prior to use of the device.

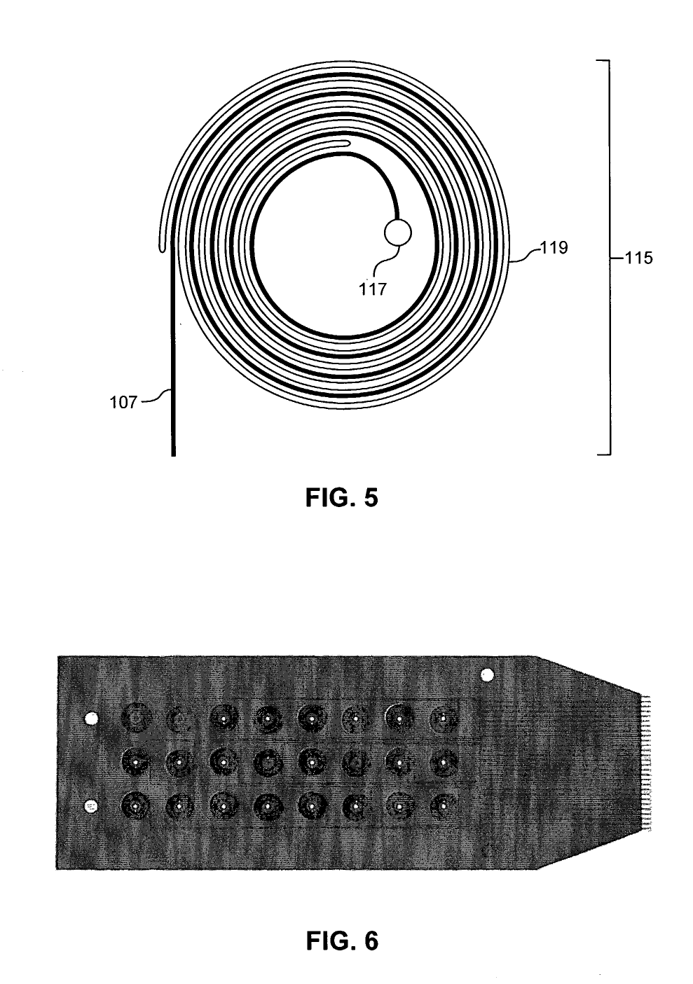

In this embodiment of the invention, the inlet ports 117a, 117b, 117c, and 117d, are shown generally as 115 in FIG. 5. The inlet ports are comprised of extendable spiral capillaries formed by the conjunction of the top plate 97 and the microfluidic housing 95 as shown in FIG. 4. Spiral microchannels in fluid communication with the upstream microchannels, shown generally as 107 in FIG. 5, located in the substantially planar upper surface of the microfluidic housing terminate at capillary openings, shown generally as 117. Alignment and placement of the top plate 97 onto the microfluidic housing 95 results in enclosed spiral microchannels. A spiral surrounding grooves, shown generally as 119, are cut completely through the microfluidic housing 95 and top plate 97 and free each of the inlet ports so that they may be extended into the individual wells via an external force such as a pin. Such flexible, extendable spiral capillaries are fully described in copending application Ser. No. 09/981,840, filed Oct. 17, 2001, entitled “EXTENSIBLE SPIRAL FOR FLEX CIRCUIT” the disclosure of which is incorporated herein by reference.

The materials used to form the microanalytical device of the invention are selected with regard to physical and chemical characteristics that are desirable for a particular application. In all cases, the device must be fabricated from a material that enables formation of high definition (or high “resolution”) features, i.e., microchannels, chambers and the like, that are of micron or submicron dimensions. That is, the material must be capable of microfabrication using, e.g., dry etching, wet etching, laser etching, molding, embossing, or the like, so as to have desired miniaturized surface features; preferably, the substrate is capable of being microfabricated in such a manner as to form features in, on and/or through the surface of the substrate. Microstructures can also be formed on the surface of the microfluidic housing by adding material thereto, for example, polymer channels can be formed on the surface of a glass substrate using photo-imageable polyimide. Also, all device materials used should be chemically inert and physically stable with respect to any reagents with which they comes into contact, under the reaction conditions used (e.g., with respect to pH, electric fields, etc.). For use in chemical processes involving high temperatures, e.g., PCR, it is important that all materials be chemically and physically stable within the range of temperatures used. For use with optical detection means, the materials used should be optically transparent, typically transparent to wavelengths in the range of about 150 nm to 800 nm. Silicon, silicon dioxide and other silicon-containing materials should be avoided, and preferred materials are those that do not strongly adsorb solutes, e.g., proteins or other biomolecules. Suitable materials for forming the present devices include, but are not limited to, polymeric materials, ceramics (including aluminum oxide and the like), glass, metals, composites, and laminates thereof.

Polymeric materials are particularly preferred herein, and will typically be organic polymers that are homopolymers or copolymers, naturally occurring or synthetic, crosslinked or uncrosslinked. Specific polymers of interest include, but are not limited to, polyimides, polycarbonates, polyesters, polyamides, polyethers, polyurethanes, polyfluorocarbons, polystyrenes, poly(acrylonitrile-butadiene-styrene)(ABS), acrylate and acrylic acid polymers such as polymethyl methacrylate, and other substituted and unsubstituted polyolefins, and copolymers thereof. Polyimide and polyetheretherketone are of particular interest, and have proven to be highly desirable substrate materials in a number of contexts. It has been demonstrated, for example, that polyimides exhibit low sorptive properties towards proteins, which are known to be particularly difficult to analyze in prior silicon dioxide-microfluidic housingd systems. Polyimides are commercially available, e.g., under the tradename Kapton™, (DuPont, Wilmington, Del.) and Upilex (Ube Industries, Ltd., Japan).

The devices of the invention may also be fabricated from a “composite,” i.e., a composition comprised of unlike materials. The composite may be a block composite, e.g., an A-B-A block composite, an A-B-C block composite, or the like. Alternatively, the composite may be a heterogeneous combination of materials, i.e., in which the materials are distinct from separate phases, or a homogeneous combination of unlike materials. As used herein, the term “composite” is used to include a “laminate” composite. A “laminate” refers to a composite material formed from several different bonded layers of identical or different materials. Other preferred composite substrates include polymer laminates, polymer-metal laminates, e.g., polymer coated with copper, a ceramic-in-metal or a polymer-in-metal composite. One preferred composite material is a polyimide laminate formed from a first layer of polyimide such as Kapton™, that has been co-extruded with a second, thin layer of a thermal adhesive form of polyimide known as KJ™, also available from DuPont (Wilmington, Del.).

The microfluidic surfaces of the device may be chemically modified to provide desirable chemical or physical properties, e.g., to reduce adsorption of molecular moieties to the interior walls of a microchannel or reaction chamber, and to reduce electroosmotic flow (“EOF”). For example, the surface of a polymeric or ceramic substrate may be coated with or functionalized to contain electrically neutral molecular species, zwitterionic groups, hydrophilic or hydrophobic oligomers or polymers, etc. With polyimides, polyamides, and polyolefins having reactive sites or functional groups such as carboxyl, hydroxyl, amino and haloalkyl groups (e.g., polyvinyl alcohol, polyhydroxystyrene, polyacrylic acid, polyacrylonitrile, etc.), or with polymers that can be modified so as to contain such reactive sites or functional groups, it is possible to chemically bond groups to the surface that can provide a variety of desirable surface properties. An exemplary modified material is polyimide functionalized so as to contain surface-bound water-soluble polymers such as polyethylene oxide (PEO), which tends to reduce unwanted adsorption and minimize nonspecific binding in biochemical processes, e.g., in DNA amplification and other methodologies involving hybridization techniques. The microfluidic surface may also be advantageously modified using surfactants (e.g., polyethylene oxide triblock copolymers such as those available under the tradename “Pluronic,” polyoxyethylene sorbitan, or “TWEEN”), natural polymers (e.g., bovine serum albumin or “BSA”), or other moieties that provide the desired surface characteristics, particularly in reducing the sorption of biomolecules such as proteins.

It should also be emphasized that different regions of a device may have chemically different microfluidic surfaces, e.g., the interior surface of a microchannel may comprise a first material, while the interior surface of a reaction chamber in fluid communication with that microchannel may comprise a second material. For example, the reaction chamber or chambers may have interior surfaces that are coated or functionalized, e.g., with PEO or the like, while the interior surfaces of microchannels associated with the reaction chamber(s) may not be coated or functionalized. Also, upstream and downstream microchannels may be fabricated so as to contain an ion exchange resin, a metal chelating compound, an affinity adsorbent material, or the like, i.e., materials selected to purify a fluid or sample by removing one or more components or types of components therefrom. In this way, different components and features present in the same device may be used to conduct different chemical or biochemical processes, or different steps within a single chemical or biochemical process.

### FABRICATION

The present microanalytical devices can be fabricated using any convenient method, including, but not limited to, micromolding and casting techniques, embossing methods, surface micromachining and bulk-micromachining. The latter technique involves formation of microstructures by etching directly into a bulk material, typically using wet chemical etching or reactive ion etching (“RIE”). Surface micromachining involves fabrication from films deposited on the surface of a substrate. An exemplary surface micromachining process is known as “LIGA.” See, for example, Becker et al. (1986), “Fabrication of Microstructures with High Aspect Ratios and Great Structural Heights by Synchrotron Radiation Lithography Galvanoforming, and Plastic Moulding (LIGA Process),” Microelectronic Engineering 4(1):35-36; Ehrfeld et al. (1988), “1988 LIGA Process: Sensor Construction Techniques via x-Ray Lithography,” Tech. Digest from IEEE Solid-State Sensor and Actuator Workshop, Hilton Head, S.C.; Guckel et al. (1991) J. Micromech. Microeng. 1: 135-138. LIGA involves deposition of a relatively thick layer of an X-ray resist on a substrate followed by exposure to high-energy X-ray radiation through an X-ray mask, and removal of the irradiated resist portions using a chemical developer. The LIGA mold so provided can be used to prepare structures having horizontal dimensions, i.e., diameters on the order of microns.

One technique for preparing the present microanalytical devices is laser ablation. In laser ablation, short pulses of intense ultraviolet light are absorbed in a thin surface layer of material. Preferred pulse energies are greater than about 100 millijoules per square centimeter and pulse durations are shorter than about 1 microsecond. Under these conditions, the intense ultraviolet light photo-dissociates the chemical bonds in the substrate surface. The absorbed ultraviolet energy is concentrated in such a small volume of material that it rapidly heats the dissociated fragments and ejects them away from the substrate surface. Because these processes occur so quickly, there is no time for heat to propagate to the surrounding material. As a result, the surrounding region is not melted or otherwise damaged, and the perimeter of ablated features can replicate the shape of the incident optical beam with precision on the scale of about one micron or less. Laser ablation will typically involve use of a high-energy photon laser such as an excimer laser of the F₂, ArF, KrCl, KrF, or XeCl type or a solid stage laser such as a Nd:YAG laser. However, other ultraviolet light sources with substantially the same optical wavelengths and energy densities may be used as well. Laser ablation techniques are described, for example, by Znotins et al. (1987) Laser Focus Electrb Optics, at pp. 54-70, and in U.S. Pat. Nos. 5,291,226 and 5,305,015 to Schantz et al.

The fabrication technique that is used must provide for features of sufficiently high definition, i.e., microscale components, channels, chambers, etc., such that precise alignment—“microalignment”—of these features is possible. “Microalignment” refers to the precise and accurate alignment of laser-ablated features, including the alignment of complementary microchannels or microcompartments with each other, inlet and/or outlet ports with microcolumns or reaction chambers, detection means with microcolumns or separation compartments, detection means with other detection means, projections and mating depressions, grooves and mating ridges, and the like.

Various means for applying a motive force along the length of the sample treatment components, such as centrifugal force or acceleration, a pressure differential, or electric potential can be readily interfaced to the microanalytical device via the inlet and outlet ports, in any of the foregoing devices. In electrophoresis, a voltage gradient will be applied across the flow path from the inlet port to the outlet port, causing components in the flowing fluid to migrate at different rates proportional to their charge and/or mass. As will be appreciated by those skilled in the art, any convenient means may be employed for applying a voltage gradient across the flow path.

We claim:

1. A microanalytical device in which a plurality of chemical and biochemical reactions can be conducted in parallel, comprising a wellplate having integrated microfluidics and electrospray emitters that are each capable of delivering a sample to a mass spectrometer.

2. The microanalytical device of claim 1, wherein the integrated microfluidics are formed by the joining of:
(a) a microfluidic housing having first and second substantially planar opposing surfaces, with a plurality of cavities and microchannels formed in the first substantially planar opposing planar surface, wherein each cavity is in fluid communication with both (i) an upstream microchannel that is in turn in fluid communication with an associated inlet port and (ii) a downstream microchannel that is in fluid communication with an associated outlet port that is in turn in fluid communication with an associated electrospray emitter; and
(b) a cover plate affixed to the first substantially planar surface, said cover plate in combination with the cavities and microchannels defining the plurality of independent, parallel sample processing compartments,
wherein the wellplate may be integrated with the microfluidic housing or the cover plate and each well in the well plate is capable of fluid communication with an inlet port of a sample processing compartment.

3. The microanalytical device of claim 2, wherein the inlet ports are housed in the microfluidic housing and the well plate is integrated with the microfluidic housing.

4. The microanalytical device of claim 2, wherein the inlet ports are housed in the cover plate and the well plate is integrated with the cover plate.

5. The microanalysis device of claim 1, wherein the well plate comprises at least 96 wells.

6. The microanalysis device of claim 1, wherein the electrospray emitters are formed of the same material the substrate.

7. The microanalytical device of claim 1, wherein the device is comprised of a polymeric material.

8. The microanalytical device of claim 7, wherein the polymeric material is selected from the group consisting of polyimides, polycarbonates, polyesters, polyamides, polyethers, polyurethanes, polyfluorocarbons, polystyrenes, poly(acrylonitrile-butadiene-styrene), polymethyl methacrylate, polyolefins, and copolymers thereof.

9. The microanalytical device of claim 8, wherein the polymeric material is polyimide or polyetheretherketone.

10. The microanalytical device of claim 2, wherein the integrated microfluidics are treated to enhance thermal stability and biofouling resistance.

11. The microanalytical device of claim 2, wherein the upstream microchannel in combination with the cover plate forms an upstream microcolumn, and the downstream microchannel in combination with the cover plate forms a downstream microcolumn.

12. The microanalytical device of claim 1, further including motive means to move fluid from each well through the sample processing compartments.

13. The microanalytical device of claim 12, wherein the motive means is not directly housed on the microanalytical device.

14. The microanalytical device of claim 13, wherein the motive means comprises a means for applying a voltage differential.

15. The microanalytical device of claim 12, wherein the motive means comprises a means for applying a pressure differential.

16. The microanalytical device of claim 2, wherein the fluid communication between each well and the inlet port is provided by spiral capillaries.

17. The microanalytical device of claim 2, wherein each cavity is sized to contain approximately 1 nL to approximately 500 μL of fluid.

18. The microanalytical device of claim 17, wherein each cavity is sized to contain approximately 100 nL to approximately 10 μL of fluid.

19. The microanalytical device of claim 2, wherein each microchannel is approximately 1 μm to 200 μm in diameter.

20. The microanalytical device of claim 19, wherein each microchannel is approximately 10 82 m to 75 μm in diameter.

21. A method for transporting a plurality of liquid samples to a mass spectrometer in parallel using at most 500 μl of each liquid sample, the method comprising:
(a) introducing approximately 1 nL to about approximately 500 μL of each liquid sample into a separate well located in a microanalytical device according to claim 1,
(b) applying a motive force to the device to move each liquid sample through the microanalytical device; and
(c) introducing each liquid sample into the mass spectrometer via the spray emitters.

22. The method of claim 21, wherein the sample fluids undergo a chemical reaction while in the microanalytical device.
